(19) United States
(12) Patent Application Publication
(10) Pub. No.: US 2020/0025989 A1
(43) Pub. Date: Jan. 23, 2020

(54) RETARDATION FILM

(71) Applicant: KANEKA CORPORATION, Osaka-shi (JP)

(72) Inventors: Ryutaro MUKAI, Settsu-shi (JP); Hiroto Koma, Settsu-shi (JP); Shinsuke Akao, Settsu-shi (JP); Takahiro Yasumoto, Settsu-shi (JP); Tomohiro Abo, Otsu-shi (JP)

(73) Assignee: KANEKA CORPORATION, Osaka-shi (JP)

(21) Appl. No.: 16/583,814

(22) Filed: Sep. 26, 2019

Related U.S. Application Data
(63) Continuation of application No. PCT/JP2018/013927, filed on Mar. 30, 2018.

(30) Foreign Application Priority Data
Mar. 31, 2017 (JP) 2017-072532

(51) Int. Cl. G02B 5/30; C08J 5/18

(52) U.S. Cl. CPC G02B 5/305; C08J 5/18; G02B 5/3083

(57) ABSTRACT

Provided are: a novel retardation film which has low photoelastic coefficient, while having good linear thermal expansion coefficient and water absorption; and the novel retardation film which additionally has high heat resistance. The above-described problem is solved by a retardation film which has an absolute value of the linear thermal expansion coefficient of 100 ppm/° C. or less, a glass transition temperature of 180° C. or more, a photoelastic coefficient of from 5×10⁻¹² m²/N to 30×10⁻¹² m²/N and a water absorption of 2.0 wt % or less, or a retardation film which has an absolute value of the linear thermal expansion coefficient of 100 ppm/° C. or less, a photoelastic coefficient of from 5×10⁻¹² m²/N to 30×10⁻¹² m²/N and a water absorption of 2.0 wt % or less.

### TECHNICAL FIELD

The present invention relates to phase difference films.

### BACKGROUND ART

In electronic material-related markets in recent years, particularly, in flexible display markets and touch panel markets, there is an increasing need for substrates having both heat resistance and transparency. Development of high-heat-resistant transparent plastic films which achieve compatibility of transparency and heat resistance, which are expected to be applied to flexible electronic device applications such as thin solar cells, electronic paper and organic EL displays as a glass substitute material, and polymer materials constituting the plastic films is highly significant because markets for next-generation electronic device application materials are expected to expand.

High heat-resistant transparent plastic films are used in image display devices and many types of high heat-resistant transparent plastic films have been developed based on various material design concepts, depending upon various optical characteristics required in the design of each display device. Among them, various phase difference films, particularly reverse wavelength dispersion films, can be used as anti-reflection layers of reflective liquid crystal display devices, touch panels and organic EL devices. For the reverse wavelength dispersion film, cellulose derivatives, polycarbonate derivatives, polyester derivatives and the like may be used.

Patent Document 1 discloses cellulose acylate derivatives having various aromatic and aliphatic acylates as substituents, wherein the maximum absorption wavelength and a molar absorption coefficient differ from each other.

Patent Document 2 discloses that a targeted reverse wavelength dispersion (R450/R550=0.81) can be achieved in a thin film of about 20 μm to 50 μm by introducing a specific aromatic acyl group into a residual hydroxyl group of a specific cellulose alkyl ether and blending (mixing) two or more types of resin each having a different degree of substitution by the aromatic acyl group, so that the degree of substitution by the aromatic acyl group is adjusted to an optimum point.
Patent Document 1: Japanese Unexamined Patent Application, Publication No. 2008-95026
Patent Document 2: WO2015/060241

### DISCLOSURE OF THE INVENTION

### Problems to be Solved by the Invention

However, in prior art typified by the above-mentioned documents, for example, in Patent Document 1, although excellent reverse wavelength dispersion and thinning remain in a trade-off relationship, and in Patent Document 2, although various optical characteristics and film thinning, which are targets, are achieved, there is room for improvement in photoelastic coefficients, coefficients of linear thermal expansion, water absorption rate and the like.

The present invention has been made in view of the above circumstances, and an object of the present invention is to provide a novel phase difference film having a good coefficient of linear thermal expansion, a good water absorption rate and a low photoelastic coefficient, and further a novel phase difference film having a high heat resistance, for example, a phase difference film made of a novel cellulose derivative having a good coefficient of linear thermal expansion, a good water absorption rate, high heat resistance and a low photoelastic coefficient.

### Means for Solving the Problems

As a result of intensive studies, the present inventors have found that the above-mentioned problems can be solved, and have completed the present invention.

Namely, the present invention provides the following:

<1>

A first aspect of the present invention is a phase difference film having a coefficient of linear thermal expansion of 100 ppm/° C. or less in absolute value, a glass transition temperature of 180° C. or more, a photoelastic coefficient of 5×10⁻¹² m²/N to 30×10⁻¹² m²/N and a water absorption rate of 2.0 wt % or less.

<2>

A second aspect of the present invention is a phase difference film having a coefficient of linear thermal expansion of 100 ppm/° C. or less in absolute value, a photoelastic coefficient of 5×10⁻¹² m²/N to 30×10⁻¹² m²/N and a water absorption rate of 2.0 wt % or less.

<3>

A third aspect of the present invention is the phase difference film according to the first aspect or the second aspect, in which in-plane retardation Re(550) is 130 nm to 160 nm, an amount of change in the in-plane retardation Re after a dry heat durability test (80° C.×1,000 hrs) is within 2.0% of the initial value and an amount of change in the in-plane retardation Re after a wet heat durability test (60° C./90% RH×1,000 hrs) is within 4.0% of the initial value.

<4>

A forth aspect of the present invention is the phase difference film according to any one of the first aspect to the third aspect, in which the thickness of the film is 50 μm or less and reverse wavelength dispersion Re(450)/Re(550) is 0.50 to 0.99.

<5>

A fifth aspect of the present invention is the phase difference film according to any one of the first aspect to the fourth aspect, with the phase difference film being constituted of a polymer material containing at least one cellulose derivative represented by the following general formula (1)

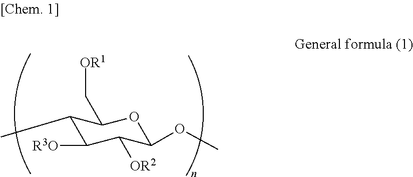

[in the general formula (1), R¹, R² and R³ are each independently selected from the group consisting of a hydrogen atom, an organosiylyl group, an acyl group and a second aliphatic group, the organosiylyl group having a first aliphatic group, an unsaturated aliphatic group or an aromatic group; and the cellulose derivative comprises (a) the organosiylyl group and (b) the acyl group or the second aliphatic group, the organosiylyl group having a first aliphatic group, an unsaturated aliphatic group or an aromatic group; and n is a positive integer],
in which a degree of substitution (D₁) by the organosiylyl group or the second aliphatic group is 0.80 to 1.55,
a degree of substitution (D₂) by the acyl group in the cellulose derivative is 0.10 to 2.00,
a degree of substitution (D₃) by the acyl group in the polymer material is 0.10 to 2.00, and
the degree of substitution (D₁) and the degree of substitution (D₂) satisfy D₁+D₂≤3.0.
<6>

A sixth aspect of the present invention is the phase difference film according to the fifth aspect, in which the cellulose derivative comprises (a) the organosilyl group and (b) the acyl group, the organosilyl group having a first aliphatic group, an unsaturated aliphatic group or an aromatic group.

<7>

A seventh aspect of the present invention is the phase difference film according to the fifth aspect or the sixth aspect, in which at least one of the organosilyl group is a trisubstituted organosilyl group.

<8>

An eighth aspect of the present invention is the phase difference film according to any one of the fifth aspect to the seventh aspect, in which at least one of the organosilyl group has at least one selected from the group consisting of a tertiary butyl group, a tertiary hexyl group and an isopropyl group.

<9>

A ninth aspect of the present invention is the phase difference film according to any one of the fifth aspect to the eighth aspect, in which at least one of the acyl group is an acyl group having a 1-naphthoyl group or a 2-naphthoyl group.

<10>

A tenth aspect of the present invention is the phase difference film according to any one of the first aspect to the ninth aspect, in which the water absorption rate is 0.1 wt % or more and 2.0 wt % or less.

<11>

An eleventh aspect of the present invention is a circular polarizing plate, comprising at least one phase difference film according to any one of the first aspect to the tenth aspect.

<12>

A twelfth aspect of the present invention is an image display device comprising the circular polarizing plate according to the eleventh aspect.

### Effects of the Invention

According to the present invention, it is possible to provide, in one embodiment, a novel phase difference film having excellent coefficient of linear thermal expansion, photoelastic coefficient and water absorption rate; and in another embodiment, a novel phase difference film having excellent heat resistance, in-plane retardation, reverse wavelength dispersion, suitable dry heat durability, wet heat durability and transparency, etc.

### PREFERRED MODE FOR CARRYING OUT THE INVENTION

An embodiment of the present invention is described below, but the present invention is not limited thereto. The present invention is not limited to the respective configurations described below and various modifications can be made within the scope shown in the claims. The embodiments and the Examples obtained by appropriately combining the technical means disclosed in the respective different embodiments and the Example are also included in the technical scope of the present invention. Also, all the patent documents described herein are incorporated herein by reference.

In the present specification, when “A to B” refers to a numerical range, the description intendeds to refer to “A or more and B or less”

The film according to one embodiment of the present invention is a phase difference film having a coefficient of linear thermal expansion of 100 ppm/° C. or less in absolute value, a glass transition temperature of 180° C. or more, a photoelastic coefficient of 5×10⁻¹² m²/N to 30×10⁻¹² m/N and a water absorption rate of 2.0 wt % or less. The film according to another embodiment of the present invention is a phase difference film having a coefficient of linear thermal expansion of 100 ppm/° C. or less in absolute value, a photoelastic coefficient of 5×10⁻¹² m²/N to 30×10⁻¹² m²/N and a water absorption rate of 2.0 wt % or less.

Examples of the polymer material that can constitute the phase difference film having these characteristics include cellulose derivatives, polycarbonate derivatives, polyester derivatives and the like. Among these, the cellulose derivative is preferable from a viewpoint of achieving, for example, a low photoelastic coefficient in film formation and excellent optical properties in a thin film state. As the cellulose derivative, that having an alkylsilyl group, an aromatic acyl group, or the like is preferable. When the polymer material is a polycarbonate derivative or a polyester derivative, that having a bisphenol skeleton, etc. having a fluorene group or an indane group is preferable.

### (Cellulose Derivatives)

The polymer material comprising a cellulose derivative according to an embodiment of the present invention contains at least one cellulose derivative represented by the following general formula (1).

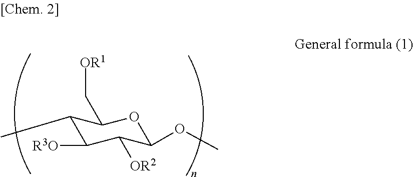

[In the general formula (1), R¹, R² and R³ are each independently selected from the group consisting of a hydrogen atom, an organosilyl group (the organosilyl group has a first aliphatic group, an unsaturated aliphatic group or an aromatic group), an acyl group and a second aliphatic group, and in the cellulose derivative, (a) the organosilyl group (the organosilyl group has a first aliphatic group, an unsaturated aliphatic group or an aromatic group) and (b) the acyl group or the second aliphatic group are included, and n is a positive integer.]

In one embodiment, the cellulose derivative includes (a) the organosilyl group (the organosilyl group has a first aliphatic group, an unsaturated aliphatic group or an aromatic group) and (b) the acyl group.

In one embodiment, the polymer material is characterized in that the degree of substitution of the organosilyl group or the second aliphatic group (D₁) in the cellulose derivative is 0.80 to 1.55, the degree of substitution (D₂) by the acyl group in the cellulose derivative is 0.10 to 2.00, the total degree of substitution (D₃) by the acyl group in the polymer material is 0.10 to 2.00, and the degree of substitution (D₁) and the degree of substitution (D_{z}) satisfy D₁+D₂≤3.0.

In one embodiment of the present invention, the organosilyl group is a trisubstituted organosilyl group.

In this case, the polymer material and the film made of the cellulose derivative may be made of one type of cellulose derivative or may be made of a plurality of types of cellulose derivatives.

For example, the film according to one embodiment of the present invention contains a polymer material comprising a mixture of a plurality of types of cellulose derivative including a polymerization unit represented by the general formula (1) and has in-plane retardation Re(550) of 130 to 160 nm, a film thickness of 50 m or less and reverse wavelength dispersion Re(450)/Re(550) of 0.50 to 0.99.

The film may be a film in which the degree of substitution (D₁) by the organosilyl group or the second aliphatic group in the cellulose derivative is 0.80 to 1.55, the degree of substitution (D₂) by the acyl group in the cellulose derivative is 0.10 to 2.00, the total degree of substitution (D₃) by the acyl group in the polymeric material is 0.10 to 2.00, and the degree of substitution (D₁) and the degree of substitution (D₂) satisfy D₁+D₂≤3.0. Here, although the details are described below, the degree of cellulose substitution (also simply referred to as the degree of substitution) represents the degree to which the hydroxyl groups from among three hydroxyl groups present at positions 2, 3 and 6 in the cellulose molecule are substituted on average.

The phase difference film according to one embodiment of the present invention has an excellent coefficient of linear thermal expansion, an excellent water absorption rate, excellent durability, excellent heat resistance, excellent transparency, an excellent coefficient of linear thermal expansion, an excellent photoelastic coefficient, excellent reverse wavelength dispersion, an in-plane retardation of about λ/4, an excellent transparency and a thin film thickness of 50 m or less.

Each of the components is explained below.

### (A) Cellulose Derivative

In the present specification, the cellulose derivative as described in the general formula (1) is a derivative obtained by converting three hydroxyl groups of β-glucose skeleton, which is a monomer constituting the cellulose, into alcohol derivatives (OR^{a}) by various known conversion reactions.

In this specification, the polymerization unit of the cellulose derivative illustrated in parentheses in the general formula (1) is also referred to as a “cellulose unit”.

Effectively selecting the cellulose derivative allows to achieve compatibility of higher heat resistance of a polymer material with transparency, a low coefficient of linear thermal expansion (CTE), a low water absorption rate and high durability of a formed film. Such compatibility has been difficult with conventional cellulose derivatives. Further, it becomes possible to impart high transparency and optical characteristics (high in-plane retardation development, an appropriate reverse wavelength dispersion and a low photoelastic coefficient) to a stretched film produced by stretching the formed film.

The cellulose derivative can be various aliphatic and aromatic esters, alkoxyls, amides, urethanes, carbonates, carbamates and the like depending on forms of substituent groups. The substituents of various types described above may co-exist in the same molecule. From a viewpoint of achieving high heat resistance, a low coefficient of linear expansion, a low water absorption rate and high durability, compatibility of good in-plane retardation with reverse wavelength dispersion and a low photoelastic coefficient of the formed film and the stretched film, R¹ to R³ represented in the general formula (1) is preferably an organosilyl group (the organosilyl group has a first aliphatic group, an unsaturated aliphatic group, or an aromatic group), an acyl group or a second aliphatic group). Further, it is more preferable that the cellulose derivative contains an organosilyl group (the organosilyl group has a first aliphatic group, an unsaturated aliphatic group, or an aromatic group) and an acyl group or a second aliphatic group in the same cellulose molecule.

From a viewpoint of imparting the reverse wavelength dispersion Re(450)/Re(550) of less than 1 to the stretched films, it is preferable that R¹ to R³ represented in the general formula (1) is an organosilyl group (the organosilyl group has a first aliphatic group, an unsaturated aliphatic group or an aromatic group) or an acyl group. Further, it is more preferable that the cellulose derivative contains an organosilyl group (the organosilyl group has a first aliphatic group, an unsaturated aliphatic group or an aromatic group) and an acyl group in the same cellulose molecule.

In order to clearly distinguish the aliphatic group possessed by the organosilyl group from the aliphatic group bonded to the oxygen atom of the cellulose unit, the former may be referred to as a “first aliphatic group” and the latter may be referred to as a “second aliphatic group”.

The cellulose derivative having an organosilyl group (the organosilyl group has a first aliphatic group, an unsaturated aliphatic group or an aromatic group) achieves high heat resistance, a low water absorption rate, a low coefficient of linear thermal expansion (CTE) and a low photoelastic coefficient while maintaining transparency when formed into a film. In addition, the retardation development of the stretched film is remarkably improved, which is preferable.

In the present specification, a glass transition temperature (hereinafter may be referred to as Tg) is used as an indicator of heat resistance of a polymer material and a film formed thereof. In the case of films based on an existing cellulose derivative, the glass transition temperature is usually in a range of 130° C. to 180° C. In the present specification, when the glass transition temperature of a film is higher than 180° C., the film is evaluated as having “high heat resistance”. In the present specification, it is assumed that the glass transition temperature of a polymer material made of a cellulose derivative is the same as the glass transition temperature of a film made of the polymer material. Therefore, a polymer material comprising a cellulose derivative which is a raw material of a film having “high heat resistance” can also be evaluated as having “high heat resistance”.

The organosilyl group (the organosilyl group has a first aliphatic group, an unsaturated aliphatic group or an aromatic group) is not particularly limited, but preferably has at least one bulky substituent. Therefore, among the organosilyl groups, a trisubstituted organosilyl group having at least one secondary or tertiary substituent is preferable.

A tertiary butyl group, a tertiary hexyl group, an isopropyl group, an isobutyl group, a phenyl group, a naphthyl group or the like falls within the bulky substituent that the organosilyl group has, but the bulky substituent is not particularly limited thereto. However, a tertiary butyl group, a tertiary hexyl group or an isopropyl group is particularly preferred.

Having the above-mentioned preferable substituent improves the water resistance of an alkoxyl group having an organosilyl group (also referred to as an alkoxysilyl group) which is normally hydrolyzable and less resistant to humidity and moisture absorption. In addition, as an unexpected effect, heat resistance of the cellulose derivative as a mother skeleton of the resin is greatly improved, for example, with a glass transition temperature (Tg) reaching 180° C. or more, while an amorphous nature of the resin is maintained. This results in a low coefficient of linear thermal expansion (CTE), a low water absorption rate, high durability and a low photoelastic coefficient. Transparent heat-resistant films developed in the market thus far by various film manufacturers are mainly super-engineered films typified by transparent polyimides and transparent polyamides. For example, in conventional amorphous cellulose derivatives such as triacetyl cellulose, there have been no materials excellent in compatibility of heat resistance, water absorption rates, durability and photoelastic coefficients as described above. Materials with high heat resistance in cellulose derivatives are limited to crystalline cellulose derivatives, such as a cellulose wholly aromatic ester typified by a cellulose trisubstituted benzoic acid ester. Since the cellulose derivatives are crystalline, it is difficult to produce transparent films, and therefore, applications other than phase difference film are often developed.

When a bulky organosilyl substituent is contained in a cellulose unit, high steric hindrance with an aromatic acyl group introduced into the same cellulose unit and an adjacent cellulose unit occurs as described below, resulting in inhibition of free rotation of the aromatic ring of the aromatic acyl group. This additionally makes it possible to achieve an effect of suppressing an increase in the photoelastic coefficient of the stretched film, as described above. As mentioned above, it is desirable that the tri-substituted organic silyl group has at least one bulky substituent such as a tertiary butyl group, a tertiary hexyl group and an isopropyl group. From a viewpoint of easy control of introduction of the organosilyl group into the cellulose skeleton, it is preferable that the organic silyl group is any one of a tertiary butyldimethylsilyl group (hereinafter, sometimes referred to as TBDMS group), a tertiary butyldiphenylsilyl group (hereinafter, sometimes referred to as TBDPS group), a tertiary hexyldimethylsilyl group (hereinafter, sometimes referred to as THDMS group) and a triisopropylsilyl group (hereinafter, sometimes referred to as TIPS group).

From a viewpoint of bulkiness of the entire organosilyl group and from a viewpoint of imparting water resistance, durability and a low coefficient of linear thermal expansion (CTE), the above-mentioned substituents can be appropriately selected depending upon the purpose. From a viewpoint of imparting water resistance and durability, the TIPS group and the TBDPS group are preferable because they have bulkiness which is the most effective in hindering access of water molecules. On the other hand, for example, when the organosilyl group further has a similar bulky substituent in addition to the tertiary butyl group or the tertiary hexyl group, the organosilyl group becomes an excessively bulky substituent as a whole. Therefore, it tends to be difficult to control the degree of substitution by the organosilyl group with respect to the cellulose skeleton to an appropriate range. From a viewpoint of imparting transparency and plasticity to the films, it may be preferable to use a TBDMS group and a THDMS group which are less bulky than those described above because the resins are easily oriented. The group of the above-mentioned substituents can be appropriately selected or used in combination from a viewpoint of the degree of difficulty of the reaction of introducing a substituent and the balance of the film characteristics. Because the substituents other than the tertiary butyl group are methyl groups in the TBDMS group, and the substituents other than the tertiary hexyl group are methyl groups in the THDMS group, the TBDMS group and the THDMS group have appropriate bulkiness from the above-mentioned viewpoint. Further, from a viewpoint of the above-mentioned characteristics and availability of industrial raw materials, it is preferable that the organosilyl group is a TIPS group and a TBDMS group. From a viewpoint of achieving the above-mentioned various physical properties in a good balance and from a viewpoint of availability, it is preferable to use the TIPS group and the TBDMS group as the organosilyl group in combination, and it is possible to easily achieve the target degree of substitution in the cellulose derivative.

The acyl group is not particularly limited as long as it has an acyl structure (RCO—). The acyl group is classified into a plurality of classes depending upon the structure of an R portion of the formula, and among them, an aliphatic acyl group and an aromatic acyl group are included.

Examples of the aliphatic acyl group include a structure in which R is formed of an alkyl group. In this case, examples of the aliphatic acyl group include various linear, branched, cyclic structures and the like depending on length of the alkyl group, and there is no particular limitation. In addition, an unsaturated alkyl group may be contained. Examples include an acetyl group, a propionyl group, a butyryl group and a cyclohexyl group.

Examples of the aromatic acyl group include a structure formed of an aromatic ring or polycyclic aromatic ring in which R is substituted or unsubstituted, a heterocyclic ring or polycyclic heterocycle in which R is substituted or unsubstituted. Here, the term “polycyclic” refers to a compound in which at least two or more aromatic rings or heterocycles share at least two or more sp2 carbons that each of the aromatic rings or the heterocycles has. The substituent is not particularly limited, and examples thereof include an aliphatic substituent, an unsaturated aliphatic substituent, an aromatic substituent, an alkoxyl group, a carbonyl group, an ester group, a halogen atom, an imide and a carbamate.

Among the substituents described above, from a viewpoint of being able to develop preferred reverse wavelength dispersion, it is preferable to introduce an aromatic acyl group, more preferably a 1-naphthoyl group or a 2-naphthoyl group, into the cellulose derivative. From a viewpoint that high reverse wavelength dispersion is developed even at a low degree of substitution, the 2-naphthoyl group is further preferable. The 2-naphthoyl group may have a substituent on the naphthalene ring. The substituent is not particularly limited, and an alkoxyl group, an ester group, an amide group, a nitrile group, a halogen, or the like can be used.

The aromatic acyl group exhibits an excellent effect on the development of reverse wavelength dispersion because of its high polarizability, and exhibits an undesirable effect of concomitantly increasing the photoelastic coefficient due to free rotation of aromatic ring. The photoelastic coefficient increases in proportion to the number of aromatic rings that the aromatic acyl group has and the degree of substitution by the aromatic acyl group in the cellulose derivative. That is, introducing an aromatic acyl group into a cellulose derivative in order to develop reverse wavelength dispersion results in a trade-off relationship that the photoelastic coefficient increases.

As general knowledge, it is known that a mechanism of color unevenness caused by a high photoelastic coefficient value of a resin having an aromatic ring derives from easiness of rotation (degree of freedom) of the aromatic ring when stress is applied to a polymer chain having the aromatic ring. Therefore, in order to reduce the photoelastic coefficient while maintaining good reverse wavelength dispersion, it is preferable to inhibit free rotation of the aromatic ring of the aromatic acyl group introduced into the molecular skeleton. In one embodiment of the present invention, an aromatic acyl group and a bulky organosilyl group are introduced into the same molecular skeleton as described above, thereby rotation of the aromatic ring is inhibited by high steric hindrance, and it is possible to achieve compatibility of the low photoelastic coefficient with the good reverse wavelength dispersion. In addition, controlling these substituents and the degree of substitution allows to achieve improvement in the coefficient of linear thermal expansion (CTE) and to achieve an effect of suppressing water absorption rate.

In the cellulose derivative represented by the general formula (1), R¹ to R³ may be an aliphatic group. The aliphatic group is any substituent constituted by an alkyl group. In this case, examples of the aliphatic group include various linear, branched cyclic structures and the like depending on length of the alkyl group, and there is no particular limitation. In addition, an unsaturated alkyl group may be contained. Examples of the aliphatic group include a methyl group, an ethyl group, a propyl group, an isopropyl group, a butyl group, an isobutyl group, a tertiary butyl group, a cyclohexyl group and the like.

By heat stretching a formed film obtained from the cellulose derivative, it is possible to produce a phase difference film which achieves high heat resistance, a low water absorption rate, high durability and a low photoelastic coefficient, which were previously difficult, in addition to compatibility of good in-plane retardation with reverse wavelength dispersion, these being usually in a trade-off relationship in other cellulose derivatives. Therefore, it is possible to greatly reduce a thickness of a film in a state in which good reverse wavelength dispersion and in-plane retardation are maintained; further, by having a low water absorption rate and high durability, the film is less susceptible to changes in film characteristics due to external factors such as moisture; an application range of multilayer-formation step is expanded utilizing high heat resistance; and thereby multilayer formation with other functional layers, which may encompass not only plastics but also a transparent conductive layer formed of an inorganic material, becomes easy. Further, a low photoelastic coefficient allows to prevent color unevenness which takes place when external stress is applied to the film. The cellulose derivative is not limited to a single derivative, and may be a mixture of two or more derivatives as long as compatibilization is possible.

In the present specification, the cellulose derivative represented by the general formula (1) included in the phase difference film is also referred to as a “polymer material”. The “polymer material” may consist of one type of cellulose derivative or a mixture of a plurality of types of cellulose derivatives. The film according to one embodiment of the present invention may include a configuration other than the above-mentioned “polymer material” to the extent that the heat resistance, the photoelastic coefficient, the water absorption rate and the durability are not impaired.

### (B) Conversion Reaction of Cellulose Derivatives

As the conversion reaction for producing the above-mentioned cellulose derivatives, known synthesis methods can be appropriately used. An example of particularly simple methods is described below, but the present invention is not limited thereto. First, commercially available powdered cellulose is subjected to a heating and cooling treatment together with an organic solvent exemplified by N,N-dimethylacetamide and lithium halide exemplified by lithium chloride to prepare a solution in which the cellulose is dissolved. Subsequently, a nucleophilic catalyst and an organic amine are added, an organosilylating agent is added dropwise and the mixture is allowed to react. Thereafter, the reaction product is washed with water and an organic solvent to synthesize a cellulose silyl ether having a predetermined degree of substitution by an organosilyl group. Subsequently, the cellulose silyl ether and an acylating agent are heated in a co-existing state in the presence of pyridine. Thereafter, the reaction product is washed with water and an organic solvent to obtain a desired cellulose derivative in which the residual hydroxyl group in the cellulose silyl ether is aromatic esterified. Conversely to the above description, it is also possible to treat commercially available powdered cellulose first with an acylating agent to introduce acyl groups, and then with an organosilylating agent to introduce organosilyl groups.

### (C) Degree of Cellulose Substitution

D, specifically D₁ to D₃, indicates how many of the three hydroxyl groups existing at positions 2, 3 and 6 in a cellulose molecule are substituted on average, and the maximum value is 3. In this case, with regard to each of the three hydroxyl groups existing at positions 2, 3 and 6 in the cellulose molecule, substantially the same number of hydroxyl groups may be substituted. On the other hand, among the three hydroxyl groups existing at positions 2, 3 and 6 in the cellulose molecule, the hydroxyl group existing at any position may be more frequently substituted, and the other hydroxyl groups may be less frequently substituted.

The degree of substitution (D₁) indicates how many of the three hydroxyl groups existing at positions 2, 3 and 6 in the cellulose molecule are substituted on average by an organosilyl group or a second aliphatic group in the various cellulose derivatives contained in the film, and the maximum value is 3. In this case, with regard to each of the three hydroxyl groups existing at positions 2, 3 and 6 in the cellulose molecule, substantially the same number of hydroxyl groups may be substituted. On the other hand, among the three hydroxyl groups existing at positions 2, 3 and 6 in the cellulose molecule, the hydroxyl group existing at any position may be more frequently substituted, and the other hydroxyl groups may be less frequently substituted.

The degree of substitution by the organosilyl group (D₁) is sometimes referred to as “degree of substitution by the organosilyl group” in particular. Similarly, the degree of substitution by the second aliphatic group (D₁) may be referred to as the “degree of substitution by the second aliphatic group” in particular. Generally, the degree of substitution (D₁) may be reworded to “degree of substitution by an RO group” or “degree of substitution by an R group” (the RO group and the R group are functional groups having structures of RO and R, respectively) (for example, when R is an ethyl group, the degree of substitution (D₁) may be referred to as “degree of substitution by an ethyl group” or “degree of substitution by an ethoxy group”).

When the cellulose derivative is not substituted by the second aliphatic group, the degree of substitution (D₁) means a degree of substitution by the organosilyl group. In this case, when two or more types of organosilyl group are mixed, the degree of substitution (D₁) is a sum of the degree of substitution by each silyl group. On the other hand, when the cellulose derivative is substituted by the second aliphatic group, the degree of substitution (D₁) is a sum of the degree of substitution by the organosilyl group and the degree of substitution by the second aliphatic group.

The degree of substitution (D₂) indicates how many of the three hydroxyl groups existing at positions 2, 3 and 6 in the cellulose molecule are acylated on average in each type of cellulose derivatives contained in the film, and the maximum value is 3. In this case, with regard to each of the three hydroxyl groups existing at positions 2, 3 and 6 in the cellulose molecule, substantially the same number of hydroxyl groups may be substituted. On the other hand, among the three hydroxyl groups existing at positions 2, 3 and 6 in the cellulose molecule, the hydroxyl group existing at any position may be substituted more, and the other hydroxyl groups may be substituted less.

A total degree of substitution (D₃) indicates how many of the three hydroxyl groups existing at positions 2, 3 and 6 in the cellulose molecule are acylated on average in the polymer material contained in the film, and the maximum value is 3. For example, when the polymer material consists of one type of cellulose derivative, the total degree of substitution (D₃) indicates how many of the three hydroxyl groups existing at positions 2, 3 and 6 in the cellulose molecule are acylated on average in the one type of cellulose derivative, and the maximum value is 3. On the other hand, when the polymer material is formed of a mixture of two or more types of cellulose derivative, the total degree of substitution (D₃) indicates how many of the three hydroxyl groups existing at positions 2, 3 and 6 in the cellulose molecule are acylated on average in the entire mixture of the two or more types of cellulose derivative, and the maximum value is 3.

The acyl group (RCO—) may take various forms depending on the structure of R. When focusing on RCO having a particular structure, the degree of substitution (D₂) and the total degree of substitution (D₃) are sometimes referred to as the “degree of substitution by an RCO group” and the “total degree of substitution by an RCO group” (the RCO group is a functional group with an RCO structure) (for example, when a cellulose molecule is substituted with a 2-naphthoyl group, the degree of substitution (D₂) is sometimes referred to as the “degree of substitution by a 2-naphthoyl group”. Likewise, the degree of substitution (D₃) is also sometimes referred to as the “total degree of substitution by a 2-naphthoyl group”).

The value of D can be calculated by a well-known method. For example, when the organosilyl group is a TBDMS group, the degree of substitution (D₁) by the organosilyl group can be quantified by the method (nuclear magnetic resonance spectroscopy: NMR) described in “Cellulose Communications 6, 73-79 (1999)”. This document is incorporated herein by reference.

As noted above, the degree of substitution (D₁) and the degree of substitution (D₂) refer to degrees of substitution in various types of cellulose derivative making up a polymer material, while the total degree of substitution (D₃) refers to a degree of substitution by an acyl group in the entire polymer material. Specifically, when the polymer material consists of one type of cellulose derivative, the value of the total degree of substitution (D₃) in the polymer material is the same as the value of the degree of substitution (D₂) in the one type of cellulose derivative. On the other hand, when the polymer material comprises a mixture of two or more types of cellulose derivative, the value of the total degree of substitution (D₃) in the polymer material is determined based on the value of degree of substitution (D₂) of each type of cellulose derivative.

Hereinafter, each of the total degree of substitution (D₃), the degree of substitution (D₁) and the degree of substitution (D₂) is described in more detail.

Firstly, the total degree of substitution (D₃) is described.

The amount of acyl group introduced into the polymer material (in other words, the total degree of substitution (D₃)) is preferably an amount capable of developing reverse wavelength dispersion. When the total degree of substitution (D₃) is in a range of 0.10 to 2.00, the likelihood that birefringence is negative becomes low in addition to the likelihood that the reverse wavelength dispersion becomes good, and therefore, both likelihoods can satisfy the characteristics of practical levels, which is preferable.

A suitable amount of acyl group to be introduced into the polymer material depends on the type of acyl group to be introduced and the type of another substituent to be introduced. For combination of a silyl group typified by the TIPS group or the TBDMS group and a 2-naphthoyl group, which is a preferable constituent in one embodiment of the present invention, the total degree of substitution (D₃) may be 0.10 to 1.00. The total degree of substitution (D₃) is preferably 0.15 to 0.50, more preferably 0.18 to 0.25, from the viewpoint of developing good reverse wavelength dispersion.

Next, the degree of substitution (D₁) is described.

Depending on the type and degree of substitution (D₁) by the organosilyl group and/or the second aliphatic group possessed by the cellulose derivative, values of phase difference development, the coefficient of linear thermal expansion (CTE), the photoelastic coefficient and the water resistance greatly change. The degree of substitution (D₁) by the organosilyl group or the second aliphatic group is preferably 0.80 to 1.55 because an appropriate amount of unsubstituted hydroxyl group is required for the acyl group introduction reaction for the purpose of developing the reverse wavelength dispersion.

When the degree of substitution (D₁) by the organosilyl group or the second aliphatic group is 0.80 or more, sufficient film strength and high solubility in a casting solvent can be obtained. On the other hand, the degree of substitution (D₁) by the organosilyl group or the second aliphatic group of 1.55 or less is preferred because extremely bulky surrounding of the residual hydroxyl group, which results in difficulty in introducing an acyl group, can be prevented; and an overly high glass transition temperature (Tg), which results in difficult application of heat stretching to the film can be also prevented. Further, there is no likelihood that an overly high degree of substitution decreases solubility of the film in a casting solvent. Therefore, the degree of substitution (D₁) by the organosilyl group or the second aliphatic group is preferably in a range of 0.80 to 1.55, as described above.

In one embodiment of the present invention, an acyl group is introduced into an OH group remaining in a cellulose ether skeleton having a degree of substitution (D₁) by an organosilyl group or a second aliphatic group in the above-mentioned range, and the formed film is thermally stretched, whereby a main chain component (cellulose silyl ether skeleton) and an acyl group of a side chain component are orthogonal to each other in the cellulose derivative.

Thereby, in the cellulose derivative, additivity is established with respect to the birefringence of both components, so that it becomes possible to develop reverse wavelength dispersion.

Next, degree of substitution (D₂) is described.

In one embodiment of the present invention, an acyl group is introduced into an OH group remaining in the cellulose silyl ether skeleton having the degree of substitution (D₁) by the organosilyl group or the second aliphatic group in the above ranges. In this case, acyl groups may be introduced into substantially all of the remaining OH groups, or acyl groups may be introduced into a part of the remaining OH groups.

The degree of substitution (D₂) is 0.10 to 2.00, preferably 0.15 to 1.00, from the viewpoint of easily achieving the desired total degree of substitution (D₁) value.

When the polymer material consists of one type of cellulose derivative (in other words, when the value of total degree of substitution (D₃) in the polymer material is the same as the value of degree of substitution (D₂) in one type of cellulose derivative constituting the polymer material), the degree of substitution (D₂) may be 0.10 to 2.00. Based on the viewpoint of developing good reverse wavelength dispersion, the degree of substitution (D₂) is preferably 0.15 to 0.50, more preferably 0.18 to 0.25.

As described above, the polymer material can be roughly classified into the case where it consists of one type of cellulose derivative and the case where it comprises a mixture of two or more types of cellulose derivative.

When the polymer material consists of one type of cellulose derivative, the value of the total degree of substitution (D₃) by the acyl group in the polymer material is the same as the value of the degree of substitution (D₂) by the acyl group in said one type of cellulose derivative. On the other hand, when the polymer material is constituted of a mixture of two or more types of cellulose derivative, the value of the total degree of substitution (D₃) by the acyl group in the polymer material can be calculated based on the values of the degrees of substitution (D₂) by the acyl group of the two or more types of cellulose derivative. As the calculation method, it is possible to suitably use a simulation method described in International Publication No. WO 2015/060241, which is incorporated herein by reference.

### (D) Retardation: Re(λ)

When the phase difference film according to an embodiment of the present invention is used, in particular, as an anti-reflection layer, the in-plane retardation of the film is preferably of the order of ¼ of a measured wavelength of said in-plane retardation. In particular, in the case of in-plane retardation Re (550) at a measurement wavelength of 550 nm, ¼ of the measurement wavelength is 137.5 nm, and therefore 130 nm to 160 nm is preferable, and 130 nm to 150 nm is more preferable.

The in-plane retardation (also referred to as in-plane phase difference) Re(λ) represents in-plane retardation measured by light having a wavelength of λ nm, and is defined by the following equation (1).

Re(λ)=ΔNxy(λ)×d (1)

The thickness direction retardation (also referred to as a thickness phase difference) Rth(λ) represents thickness direction retardation measured by light having a wavelength of λ nm, and is defined by the following equation (2).

Rth(λ)=ΔNxz(λ)×d (2)

Here, ΔNxy(λ) represents in-plane birefringence measured with light having a wavelength of λ nm, ΔNxz(λ) represents birefringence in the thickness direction measured with light having a wavelength of λ nm, and d represents a thickness (μm) of the film. The in-plane birefringence in this context refers to a difference between the maximum refractive index and the minimum refractive index of refractive indexes in the plane of the film. The birefringence in the thickness direction refers to a difference between a value obtained by dividing the sum of the maximum refractive index and the minimum refractive index in the plane of the film by 2 and the refractive index in the thickness direction.

### (E) Reverse Wavelength Dispersion: Re(450)/Re(550)

When a film according to an embodiment of the present invention is used for phase difference films, in particular for anti-reflection layers, the reverse wavelength dispersion Re(450)/Re(550) of the film is preferably 0.50 to 0.99, more preferably 0.60 to 0.90, more preferably 0.70 to 0.90, more preferably 0.75 to 0.90, even more preferably 0.80 to 0.89, and particularly preferably 0.81 to 0.83. When the in-plane retardation and the reverse wavelength dispersion are within the above-mentioned ranges, the anti-reflection function is satisfactory over the entire wavelength range, which is preferable.

(F) Photoelastic Coefficient: K (×10⁻¹² m²/N)

A photoelastic coefficient is a value obtained by dividing an amount of change in birefringence when a stress is applied to the film or the like, by the stress. When a film having a high photoelastic coefficient is used for a liquid crystal display device, an organic electroluminescence display or the like and the film is pasted on a substrate, the film receives a stress due to a difference with respect to a coefficient of thermal expansion of the substrate, and the phase difference greatly changes. A film having a large photoelastic coefficient is not preferable as a film to be used for a liquid crystal display device or the like because a change in the phase difference adversely affects the function of the liquid crystal display device or the like (e.g., color unevenness occurs in the display device which comprises the film, or the like)

From the above-described matters, the photoelastic coefficient of the film according to an embodiment of the present invention is preferably low. When used in anti-reflection layers of actual products (image display devices such as liquid crystal display devices and organic electroluminescence), the photoelastic coefficient K of phase difference film is preferably 5×10⁻¹² m²/N to 30×10⁻¹² m²/N, more preferably 5×10⁻¹² m²/N to 20×10⁻¹² m²/N, and even more preferably 5×10⁻¹² m²/N to 15×10⁻¹² m²/N.

### (G) Haze

A value of haze of the phase difference film (e.g., a stretched film) according to an embodiment of the present invention is not particularly limited, but is preferably 2.00% or less, more preferably 1.00% or less, and even more preferably 0.50% or less. The value of haze within the above range is preferable, because the value is advantageous in that it is possible to increase the total light transmittance of the stretched film, thereby to improve the transparency of the stretched film.

### (H) Film Thickness

When the phase difference film according to one embodiment of the present invention is used as a phase difference film, in particular, as an anti-reflection layer, upon considering the total thickness of the entire anti-reflection layer, a thickness of the film is 50 m or less, preferably 40 μm or less, more preferably 30 μm or less. The lower limit of the film thickness is not particularly limited, but 0.01 μm can be exemplified.

The thickness of the film may be even thinner as long as the desired in-plane retardation and reverse wavelength dispersion are satisfied. On the other hand, when the film has a thickness of not more than the above-described thickness, during a manufacturing process, for example, by a solvent casting method, a drying time of the solvent does not become excessively long and productivity is not lowered.

### (I) Glass Transition Temperature (Tg)

When a polymer substance, such as a phase difference film according to an embodiment of the present invention, in a molten state is rapidly cooled, the polymer substance changes to a glass state. The temperature at which the change occurs is referred to as glass transition temperature and can be measured, for example, by the method described in the Examples.

The glass transition temperature is a heat-resistant index, and in the case of the phase difference film according to an embodiment of the present invention, the glass transition temperature is preferably 180° C. or more, more preferably 200° C. or more. It should be noted that the glass transition temperature is also present for the polymer material according to an embodiment of the present invention, and the value thereof can be regarded as the glass transition temperature of the phase difference film consisting only of the polymer material.

### (J) Coefficient of Linear Thermal Expansion (CTE)

Plastic materials, such as the phase difference film according to one embodiment of the present invention, thermally expand in length and volume at elevated ambient temperatures. A value obtained by expressing the amount of change per temperature as an inverse number is referred to as a coefficient of linear thermal expansion and the measured coefficient of linear thermal expansion is also present in the phase difference film according to an embodiment of the present invention. For example, it can be measured by the methods described in the Examples.

The coefficient of linear thermal expansion is an index for evaluating stresses generated when the phase difference film is laminated with other functional layers, etc. In the case of multilayered films, etc., when the difference in the values of coefficients of linear thermal expansion of the respective layers is large, serious problems such as breakage of each layer due to warpage of the film or peeling of the interface occurs. Therefore, it is preferable that the absolute values of coefficients of linear thermal expansion of the respective layers are as close as possible to each other. 100 ppm/° C. or less is preferable, 80 ppm/° C. or less is more preferable, and 70 ppm/° C. or less is even more preferable.

### (K) Water Absorption Rate

Plastic materials, such as phase difference film according to an embodiment of the present invention, have a moisture content that varies depending on the type of main chain skeleton or the type of substituent. Materials for display electronic equipment typified by an optical film are easily negatively influenced by changes in characteristics, generally, due to, in particular, moisture absorption, though depending on characteristics as a constituent member. Usually, a weight increase rate after a piece of film is immersed in water for 24 hours and taken out into air is preferably 2 wt % or less with respect to the initial value, more preferably 1 wt % or less, and even more preferably 0.5 wt % or less.

Materials for display electronic equipment to which a phase difference film is applied also typically have a water absorption rate, and absorbing water causes swelling or shrinkage, resulting in dimensional changes. When such a dimensional change in the materials for display electronic equipment occurs, breakage of each layer due to warpage, peeling of the interface, and the like may occur. Therefore, the water absorption rate of phase difference film is preferably 0.1 wt % or more, more preferably 0.15 wt % or more, and still more preferably 0.17 wt % or more so that the phase difference film to be applied can follow the dimensional change of the materials for display electronic equipment.

### (L) Durability Test (Dry Heat Test, Wet Heat Test)

Plastic materials, such as the phase difference film according to one embodiment of the present invention, exhibit a property change against external heat or a humid environment, though there is difference in superiority depending on the type of main chain skeleton or the type of substituent. Especially in the case of devices such as display equipment that are supposed to operate for a long period of time, even though an amount of change is very small when focusing on an important characteristic of each film, the amount of change is accumulated when a long period of time elapses and a serious change in the characteristic sometimes occurs. Therefore, durability tests are performed on the assumption of long-term operation, and a decision of YES or NO is often made based on the amount of change of the characteristic. Especially, since most of the polymer material of the stretched film is oriented, there is a concern that the characteristics of the polymer material have been changed by disturbance of orientation due to heat or water content even in a temperature region lower than the glass transition or melting temperature region. For this reason, within a range assumed when a device such as a display equipment is actually operated, severe conditions (heat and humidity) are set, and a long-term durability test is performed. In the phase difference film according to an embodiment of the present invention, variation in values in the phase difference in the dry heat environment and the wet heat environment is the most significant characteristic. Thus, in the respective test environments, an amount of change is calculated by setting an initial value of phase difference of a stretched film as a base point, and the amount of change can be used as the durability judgment index.

In one embodiment, the dry heat test evaluates the rate of change in in-plane retardation of a film under dry heating conditions, such as in a heating and drying oven, and the wet heat test evaluates the rate of change in in-plane retardation of a film under highly humid and heated conditions, such as in a humidified heating oven. In both the dry heat test and the wet heat test, smaller rates of change in the in-plane retardation are preferred. For example, the absolute value of the rate of change in the in-plane retardation is preferably 4% or less, more preferably 2% or less, and even more preferably 1% or less.

### (M) Third Component

When a film according to an embodiment of the present invention is manufactured from a polymer material, additives such as a plasticizer and a heat stabilizer, an ultraviolet stabilizer, an in-plane retardation increasing agent and a filler may be added as needed as third components. In particular, it is effective to add a plasticizer for a purpose of compensating for brittleness of the obtained film or for a purpose of improving processing characteristics such as stretching. Blending amounts of these third components may be any amount, as long as desired optical characteristics are not impaired.

### (N) Molecular Weight of the Cellulose Derivative

The molecular weight of the cellulose derivative (resin) used in the present invention is not particularly limited as long as film molding is possible. For example, in order to obtain a film having excellent toughness, the number average molecular weight of the resin is preferably 10,000 to 400,000. From the viewpoint of availability, it is preferable that the number average molecular weight of the resin is 20,000 to 200,000. When the number average molecular weight is 10,000 or more, sufficient toughness is imparted to the film. On the other hand, the number average molecular weight of 400,000 or less is preferable because the resin is sufficiently dissolved in the solvent, thereby this prevents a decrease in the solid content concentration of the resin solution, resulting in prevention of an increase in the amount of solvent to be used during solution casting.

### (O) Film Forming Method

The phase difference film of the present invention is an unstretched formed film (also referred to as an unstretched film) or may be a stretched film manufactured by stretching a formed film, and is more preferably a stretched film. The unstretched formed film can be prepared according to a well-known method.

Examples of typical molding methods of an unstretched film include a melt extrusion method in which a molten resin is extruded from a T die or the like to form a film, and a solvent casting method in which a solvent in which the resin is dissolved is cast on a support and the solvent is dried by heating to form a film. It is preferable to use the solvent casting method because a film with good thickness accuracy can be obtained relatively easily.

The solvent used when the solvent casting method is employed is not particularly limited, as long as the cellulose derivative used in the present invention is dissolved. As the solvent, a halogenated hydrocarbon solvent such as methylene chloride or chloroform, a ketone-based solvent such as acetone, methyl ethyl ketone or methyl isobutyl ketone, an aromatic hydrocarbon solvent such as toluene or xylene, an ester-based solvent such as ethyl acetate or butyl acetate, or the like can be used. Among them, the halogenated hydrocarbon solvent and the aromatic hydrocarbon solvent are preferable because they are easy to dissolve the resin material, have a low boiling point and tend to increase the transparency of the film. Since, in particular, methylene chloride has a boiling point as low as 40° C. and has high safety against fire or the like during drying, it is particularly preferable as a solvent used in manufacturing a film according to an embodiment of the present invention.

Although it is preferable to use the halogenated hydrocarbon solvent or the aromatic hydrocarbon-based solvent, or the like alone as a solvent to be used in one embodiment of the present invention from the viewpoint of recovery and reuse, it is also possible to use a mixed solvent of these solvents and other solvents. Examples of the other solvents include alcohols. It is also possible to use mixed solvents containing from 70% to 99% by weight and from 1% to 30% by weight of alcohol.

When a mixed solvent is used, an alcohol having 3 or less carbon atoms is preferable as the alcohol, and ethyl alcohol is more preferable because it is safe and has a low boiling point. Further, in order to suppress cost, it is preferable to contain 1 to 10 parts by weight of alcohol having 3 or less carbon atoms other than ethyl alcohol, in 100 parts by weight of alcohol. As the alcohol having a carbon number of 3 or less other than the above-mentioned ethyl alcohol, isopropyl alcohol is particularly preferably used from the viewpoint of safety and boiling point.

### (P) Solvent Casting Method

When the film is formed by the solvent casting method, the resin is dissolved in a solvent, the solvent is cast on a support, and the solvent is dried to form a film.

The preferred viscosity of the solution in which the resin is dissolved is from 10 poise to 50 poise, more preferably from 15 poise to 50 poise. Examples of the preferred support include stainless steel endless belts and films (polyimide films, polyethylene terephthalate films and the like) can be used.

The drying after casting can be carried out while the film is supported on the support, but if necessary, the preliminary-dried film until the film has a self-supporting property can be peeled off from the support and further dried.

For drying, a float method, a tenter method and a roll conveying method can be generally used. Any of these drying methods may be used, but the method by the roll conveying method is preferable because it has an advantage that the direction of stress applied to the film can be easily made constant.

Also, it is an effective method to dry the film in an atmosphere in which the humidity is kept low so that the film does not absorb moisture while the solvent is dried for obtaining the film according to an embodiment of the present invention having high mechanical strength and high transparency.

### (Q) Stretching Ratio

The phase difference film according to an embodiment of the present invention is preferably a film (also referred to as a stretched film) obtained by stretching an unstretched film obtained as described above at least uniaxially and performing an orientation treatment according to a known stretching method. The stretching method can be a uniaxial or biaxial heat stretching method. In order to obtain the phase difference film of the present invention, it is preferable to employ a vertical uniaxial stretching technique. Further, in a case where the phase difference film of the present invention is to be used as an anti-reflection layer, a free-end uniaxial stretching technique is preferable because it is important that the phase difference film has a property of being uniaxial.

The stretching ratio X is expressed by the following equation (2):

X={(L−L0)/L0}×100 (2)

where L0 denotes a length of the unstretched film, and L denotes a length of the stretched film.

The stretching ratio to be used in production of the phase difference film of the present invention is preferably not less than 20% and not more than 200%, more preferably not less than 20% and not more than 150%, and particularly preferably not less than 30% and not more than 100%.

The stretching ratio of 200% or less is preferable, because it is possible to prevent the in-plane retardation of the stretched film from exceeding a target numerical range and the strength in the direction perpendicular (TD direction) to the stretching direction from being excessively lowered due to the overorientation of the polymer material.

On the other hand, when the stretching ratio is 20% or more, the birefringence of the stretched film becomes sufficiently large to prevent the thickness of the film having a desired in-plane retardation due to shrinkage of the film from becoming too thick.

### (R) Stretching Temperature and Stretching Speed

Stretching temperatures are preferably selected between (Tg−30°) C and (Tg+30)° C. relative to the glass transition temperature Tg of the films. Particularly preferred stretching temperatures range from (Tg−10°) C to (Tg+30°) C. A stretching temperature which falls within the above temperature ranges allows to produce a phase difference film that has less variations in phase difference and to achieve all of the optimum reverse wavelength dispersion, the optimum in-plane retardation and the optimum photoelastic coefficient (specifically, a low photoelastic coefficient) in a compatible manner.

The stretching speed is preferably 10%/minute or more, and more preferably 20%/minute or more. Further, the stretching speed is preferably 500%/minute or less, and more preferably 200%/minute or less. In the case of sequential biaxial stretching, the first and second stretching speed may be the same or different.

### (S) Circular Polarizing Plate and Image Display Devices

The film of the present invention can be used as a phase difference film (also referred to as λ/4 plate) with retardation of the order of ¼ of a measured wavelength A, in particular, as a phase difference film with excellent reverse wavelength dispersion. Further, since a required phase difference can be achieved with an unprecedented thin thickness, the film of the present invention can also be used as an anti-reflection layer even in applications in which film thickness reduction or higher flexibility is required, such as a mobile device or the like including a smart phone. A form of the anti-reflection layer includes a circular polarizing plate containing the film according to an embodiment of the present invention.

A circular polarizing plate is an optical element that converts unpolarized light into circularly polarized light. The film used for the circularly polarizing plate is particularly preferably a stretched film. Examples of a configuration of the circular polarizing plate include a laminate in which a polarizer and a film according to an embodiment of the present invention are pasted to each other such that an absorption axis of the polarizer and a slow axis of the film according to an embodiment of the present invention form an angle of 45°. An adhesive layer and a polarizer protective film used in this case may have any configuration. These anti-reflection layers can be usefully used in liquid crystal display devices and image display devices such as organic EL. The film according to the embodiment of the present invention can also be used as a polarizer protective film. The surface of the film according to an embodiment of the present invention may be subject to optical adjustment such as hard coat, index matching, or a surface treatment for prevention of static charge or the like. In addition, a transparent conductive layer may be provided on the film according to an embodiment of the present invention and used for a touch panel or an electromagnetic wave shield.

### EXAMPLES

Hereinafter, the Examples of the present invention are described, but the present invention is not limited to these Examples.

### <1. Measurement Methods>

The characteristic values and the like disclosed in this specification were obtained by the following evaluation methods.

### (1) In-Plane Retardation and Reverse Wavelength Dispersion

The in-plane retardation (Re) and wavelength dispersion characteristics were measured using OPTIPRO manufactured by Shintech Inc. For the in-plane retardation, a measured value at a measured wavelength of 550 nm was adopted, and the wavelength dispersion characteristic (R450/R550) was calculated from a ratio of the respective values measured at 450 nm and 550 nm.

### (2) Thicknesses

Thickness was measured using an electronic micrometer manufactured by Anritsu Corporation.

### (3) Glass Transition Temperatures (Tg)

The glass transition temperature was measured using a thermal mechanical analyzer TMA-4000SA manufactured by Bruker AXS GmbH. Specifically, while a 3 g tensile load was applied to a piece of film cut into 5 mm×20 mm, the temperature of the film was raised at 3° C./min. in a nitrogen-atmosphere. Temperatures and film elongation ratios were plotted on an X-axis and a Y-axis, respectively, in a chart. Tg was defined as a temperature at which two tangent lines before and after film elongation started intersects in the chart, and the Tg was calculated.

### (4) Photoelastic Coefficients

The photoelastic coefficient was measured using OPTIPRO manufactured by Shintech Inc. Specifically, a tensile load was applied to a piece of film cut into 15 mm×60 mm, and the phase difference change was measured each time the tensile load was changed by 100 g from 0 g to 1100 g. Stresses calculated from the tensile load values were plotted on an X-axis and birefringence calculated from measured values of phase difference and film thicknesses was plotted on a Y-axis in a chart. A slope of a straight line in the chart was defined as photoelastic coefficient, and the photoelastic coefficients were calculated.

### (5) Hazes

The haze was measured using a haze meter (HZ-V3 manufactured by Suga Test Instruments Co., Ltd.).

### (6) Number Average Molecular Weight and Weight Average Molecular Weight

Gel permeation chromatography (GPC) manufactured by Shimadzu Corporation was used for the measurement. 3 mg of a sample was dissolved in 2 mL of chloroform, chloroform was used as a mobile phase, and a flow rate was set to 1.0 mL/min. As a column, K-2006M and K-2001 from Shodex were used, and the measurement was conducted at the column temperature of 40° C. The number average molecular weight and the weight average molecular weight were calculated by converting each measurement data using a calibration curve prepared using a polystyrene standard sample.

### (7) Degree of Substitution

The degree of substitution was quantified using integrated intensities of spectra assigned to the respective substituents using a 400 MHz ¹H-NMR manufactured by Bruker. Specifically, an introduction rate of the organosilyl group and an introduction rate of the second aliphatic group in the degree of substitution (D₁) were obtained from ratio of an integrated intensity of 3.1 to 5.2 ppm assigned to protons on a cellulose ring relative relative to an integrated intensity of −0.3 to 1.2 ppm of protons assigned to the first aliphatic group of the organosilyl group and an integrated intensity of 0.5 to 4.0 ppm of protons assigned to the second aliphatic group. The same method was used for an acyl group in the degree of substitution (D₂). In the case of an aromatic ring acyl group, the degree of substitution was obtained from a ratio of an integrated intensity of 3.1 to 5.2 ppm assigned to protons on a cellulose ring to an integrated intensity of 6.8 to 9.0 ppm assigned to protons on the aromatic ring of the acyl group. For a degree of substitution of an aliphatic acyl group of cellulose derivative 16 described in Comparative Example 4, a value published by the manufacturer was used as it was as the degree of substitution (D₂).

### (8) Coefficient of Linear Thermal Expansion (CTE)

The coefficient of linear expansion was measured using a thermomechanical analyzer TMA-4000SA manufactured by Bruker-AXS GmbH. Specifically, while a tensile load of 3.1 g was applied to a piece of film cut into 4 mm×20 mm, the temperature of the film was raised and lowered at 10° C./min in a temperature range not exceeding the glass transition temperature in a nitrogen atmosphere. A chart was prepared in which temperatures and amounts of change in length were plotted on an X-axis and a Y-axis, respectively. In the temperature lowering process, a slope in a temperature range in which the slope was constant was defined as CTE, and the CTE was calculated by the least squares method.

### (9) Water Absorption Rate

The formed film was cut into a piece of 300 mm×300 mm, which was dried in a heating oven at 150° C. for 30 minutes. Thereafter, the piece of film was placed in a vacuum desiccator and allowed to cool to room temperature, and then the piece of film was taken out and weight (A) was measured. The film was immersed in distilled water and was taken out 24 hours later. Water on the surface of the taken-out piece of film was wiped off, and weight (B) was measured. From the obtained values of (A) and (B), water absorption rate was calculated by the following equation.

Water absorption rate=((B)−(A))/(A)×100

### (10) Dry Heat Durability Test (80° C.×1,000 Hrs)

A piece of film stretched under predetermined conditions was placed in a heating oven set at 80° C., and the in-plane retardation value was measured over time. When measuring the in-plane retardation value, the piece of film taken out from the oven was subjected to humidity control at 23° C./55% RH for 4 hours, and then measurement was carried out. An amount of change in the in-plane retardation value relative to the original in-plane retardation value was expressed as a percentage and used as an index of dry heat durability test.

(11) Wet Heat Durability Test (60° C./90% RH×1,000 hrs)

A piece of film stretched under predetermined conditions was placed in an environmental tester (LH-21-11M, manufactured by Nagano Science) at 60° C./90% RH, and in-plane retardation values were measured over time. When the in-plane retardation value was measured, the piece of film taken out from the environmental tester was humidified at 23° C./55% RH for 4 hours and then measured. The amount of change in the in-plane retardation value relative to the original in-plane retardation value was expressed as a percentage and used as an index of wet heat durability.

### <2. Cellulose Derivatives>

Hereinafter, a specific method for synthesizing a cellulose derivative is described.

### (Synthesis Example 1) (Synthesis of Cellulose Derivative 1: TIPS-TBDMS Cellulose-2-Naphthoate: D₁=1.16, D₂=0.17)

Powdered cellulose W-400G manufactured by Nippon Paper Chemicals Co., Ltd. (48.0 g: 296.1 mmol) and lithium chloride (75.30 g: 1176.5 mmol) were weighed and fed into a four-neck reactor. Thereafter, a stirring rod with a crescent-shaped spatula was installed in the four-necked reactor, and a Dimroth condenser tube, a dropping funnel, a thermocouple and a calcium chloride tube were attached thereto. Subsequently, N,N-dimethylacetamide (800 mL) was fed and heated and stirred at 150° C. for 2 hours, followed by natural cooling to room temperature to obtain a homogeneous solution of cellulose.

Triethylamine (71.90 g: 710.6 mmol) was added to the homogeneous solutions. Further, triisopropyl chlorosilane (114.2 g: 592.2 mmol) and tertiary butyl dimethyl chlorosilane (4.9 g: 32.6 mmol) dissolved in N,N-dimethylacetamide (150 ml) were added dropwise from the dropping funnel under stirring, and the reaction mixture was stirred at room temperature for 5 hours.

After the reaction was quenched by adding 1,000 mL of methanol, the reaction solution was added dropwise into 900 mL of methanol, stirred to generate white precipitates, and the white precipitates were filtered. An operation of dropwise addition, stirring, and filtration was repeated three times, and then the obtained precipitates were dried under vacuum at 80° C. for 5 hours using a vacuum oven. The product obtained was analyzed using 400 MHz ¹H-NMR manufactured by Bruker to confirm that the product was alkylsilyl cellulose ether, an intermediate, and the degree of substitution was calculated to be D₁=1.16 (degree of substitution by triisopropylsilyl=1.06, degree of substitution by tertiary butyldimethylsilyl=0.10). (Molar yield: 94%, yield: 94.52 g)

The intermediate alkylsilyl cellulose ether (50.0 g: 147.4 mmol) was then weighed and fed into a four-neck reactor. Thereafter, a stirring rod with a crescent-shaped spatula was installed in the four-necked reactor, and a Dimroth condenser tube, a dropping funnel, a thermocouple and a calcium chloride tube were attached thereto. Subsequently, pyridine (700 mL) was fed, and the mixture was stirred with a stirring rod under heating at 80° C. until the cellulose silyl ether was dissolved. After confirming that the solution became clear, 2-naphthoyl chloride (7.30 g: 38.3 mmol) dissolved in pyridine (70 ml) was added dropwise at 80° C. After the dropwise addition, the mixture was stirred with the stirring rod for 5 hours, and then the reaction solution was dropped into 1,000 mL of methanol and stirred to prepare a homogeneous solution. An operation including adding the homogeneous solution dropwise to 1,000 mL of methanol and stirring was repeated three times to obtain white precipitates. The white precipitates were then dried under vacuum in a vacuum oven for 5 hours at 80° C. to obtain a desired powdery cellulose derivative 1 (molar yield: 98%, yield: 52.83 g).

The cellulose derivative 1 was analyzed with 400 MHz-¹H-NMR manufactured by Bruker and was confirmed to be a target cellulose derivative and the degree of substitution was calculated. As a result, D₁=1.16 (degree of substitution by triisopropylsilyl=1.06, degree of substitution by tertiary butyldimethylsilyl=0.10) and D=0.17.

### (Synthesis Example 2) (Synthesis of Cellulose Derivative 2: TIPS-TBDMS Cellulose-2-Naphthoate: D₁=1.26, D₂=0.13)

Target cellulose derivative 2 was obtained by using the same method as in Synthesis Example 1, except that tertiary butyl dimethylchlorosilane (11.2 g: 74.0 mmol), the intermediate, alkylsilylcellulose ether (25.0 g: 71.6 mmol), 2-naphthoyl chloride (2.73 g: 14.3 mmol) and pyridine (total: 385 mL) were used (molar yield: 97%, yield 25.79 g).

The cellulose derivative 2 was analyzed with 400 MHz-¹H-NMR manufactured by Bruker and was confirmed to be the target cellulose derivative and the degree of substitution was calculated. As a result, D₁=1.26 (degree of substitution by triisopropylsilyl=1.02, degree of substitution by tertiary butyldimethylsilyl=0.24) and D₂=0.13.

### (Synthesis Example 3) (Synthesis of Cellulose Derivative 3: TIPS-TBDMS Cellulose-2-Naphthoate: D₁=1.34, D₂=0.17)

Target cellulose derivative 3 was obtained by using the same method as in Synthesis Example 1, except that tertiary butyl dimethylchlorosilane (15.6 g: 103.6 mmol), triethyl amine (74.9 g: 740.2 mmol), the intermediate, alkylsilylcellulose ether (50.0 g: 138.7 mmol) and 2-naphthoyl chloride (6.88 g: 36.1 mmol) were used (molar yield: 99%, yield 53.45 g).

The cellulose derivative 3 was analyzed with 400 MHz-¹H-NMR manufactured by Bruker and was confirmed to be the target cellulose derivative and the degree of substitution was calculated. As a result, D₁=1.34 (degree of substitution by triisopropylsilyl=1.02, degree of substitution by tertiary butyldimethylsilyl=0.32) and D₂=0.17.

### (Synthesis Example 4) (Synthesis of Cellulose Derivative 4: TIPS-TBDMS Cellulose-2-Naphthoate: D₁=1.04, D₂=0.20)

Target cellulose derivative 4 was obtained by using the same method as in Synthesis Example 1, except that tertiary butyl dimethylchlorosilane (5.4 g: 35.5 mmol), the intermediate, alkylsilylcellulose ether (40.0 g: 124.1 mmol), 2-naphthoyl chloride (7.10 g: 37.2 mmol) and pyridine (total: 615 mL) were used (molar yield: 98%, yield 43.21 g).

The cellulose derivative 4 was analyzed with 400 MHz-¹H-NMR manufactured by Bruker and was confirmed to be the target cellulose derivative and the degree of substitution was calculated. As a result, D₁=1.04 (degree of substitution by triisopropylsilyl=0.92, degree of substitution by tertiary butyldimethylsilyl=0.12) and D₂=0.20.

### (Synthesis Example 5) (Synthesis of Cellulose Derivative 5: TBDMS Cellulose-2-Naphthoate: D₁=1.15, D₂=0.25)

Target cellulose derivative 5 was obtained by using the same method as in Synthesis Example 1, except that powdered cellulose W-400G manufactured by Nippon Paper Chemicals Co., Ltd. (24.0 g: 148 mmol) as a cellulose material, lithium chloride (37.7 g: 888.2 mmol), tertiary butyl dimethylchlorosilane (40.2 g: 266.5 mmol), no triisopropyl chlorosilane, triethyl amine (27.0 g: 266.5 mmol), N,N-dimethyl acetoamide (total: 500 mL), the intermediate, alkylsilylcellulose ether (9.5 g: 31.7 mmol), 2-naphthoyl chloride (2.42 g: 12.7 mmol) and pyridine (total: 150 mL) were used (molar yield: 89%, yield 9.42 g).

The cellulose derivative 5 was analyzed with 400 MHz-¹H-NMR manufactured by Bruker and was confirmed to be the target cellulose derivative and the degree of substitution was calculated. As a result, D₁=1.60 and D₂=0.14.

### (Synthesis Example 6) (Synthesis of Cellulose Derivative 6: TBDMS Cellulose-2-Naphthoate: D₁=1.20, D₂=0.21)

Target cellulose derivative 6 was obtained by using the same method as in Synthesis Example 5, except that powdered cellulose W-400G manufactured by Nippon Paper Chemicals Co., Ltd. (36.0 g: 222.1 mmol) as a cellulose material, lithium chloride (56.5 g: 1332.3 mmol), tertiary butyl dimethylchlorosilane (66.9 g: 444.1 mmol), triethyl amine (44.9 g: 444.1 mmol) N,N-dimethyl acetoamide (total: 750 mL), the intermediate, alkylsilylcellulose ether (40.0 g: 132.7 mmol), 2-naphthoyl chloride (8.09 g: 42.5 mmol) and pyridine (total: 615 mL) were used (molar yield: 92%, yield 40.75 g).

The cellulose derivative 6 was analyzed with 400 MHz-¹H-NMR manufactured by Bruker and was confirmed to be the target cellulose derivative and the degree of substitution was calculated. As a result, D₁=1.20 and D₂=0.21.

### (Synthesis Example 7) (Synthesis of Cellulose Derivative 7: TBDMS Cellulose-2-Naphthoate: D₁=1.23, D₂=0.22)

Target cellulose derivative 7 was obtained by using the same method as in Synthesis Example 5, except that powdered cellulose W-400G manufactured by Nippon Paper Chemicals Co., Ltd. (48.0 g: 296.1 mmol) as a cellulose material, lithium chloride (75.3 g: 1776.5 mmol), tertiary butyl dimethylchlorosilane (89.2 g: 592.2 mmol), triethyl amine (59.9 g: 592.2 mmol), N,N-dimethyl acetoamide (total: 1,000 mL), the intermediate, alkylsilylcellulose ether (20.0 g: 66.3 mmol), 2-naphthoyl chloride (3.92 g: 20.6 mmol) and pyridine (total: 300 mL) were used (molar yield: 84%, yield 18.66 g).

The cellulose derivative 7 was analyzed with 400 MHz-¹H-NMR manufactured by Bruker and was confirmed to be the target cellulose derivative and the degree of substitution was calculated. As a result, D₁=1.23 and D₂=0.22.

### (Synthesis Example 8) (Synthesis of Cellulose Derivative 8: TBDMS Cellulose-2-Naphthoate: D₁=1.58, D₂=0.20)

Target cellulose derivative 8 was obtained by using the same method as in Synthesis Example 5, except that powdered cellulose W-400G manufactured by Nippon Paper Chemicals Co., Ltd. (24.3 g: 150 mmol) as a cellulose material, lithium chloride (38.15 g: 900 mmol), tertiary butyl dimethylchlorosilane (58.78 g: 390 mmol), triethyl amine (39.46 g: 390 mmol), N,N-dimethyl acetoamide (total: 450 mL), the intermediate, alkylsilylcellulose ether (20.8 g: 60 mmol), 2-naphthoyl chloride (5.38 g: 28.2 mmol) and pyridine (total: 320 mL) were used (molar yield: 93%, yield 21.0 g).

The cellulose derivative 8 was analyzed with 400 MHz-¹H-NMR manufactured by Bruker and was confirmed to be the target cellulose derivative and the degree of substitution was calculated. As a result, D₁=1.58 and D₂=0.20.

### (Synthesis Example 9) (Synthesis of Cellulose Derivative 9: Ethylcellulose-2-Naphthoate: D₁=2.60, D₂=0.40)

As cellulose ether, ethylcellulose MED-70 (11.74 g: 50 mmol, D₁=2.60) manufactured by Dow Chemical Company was weighed and fed into a four-neck reactor. Thereafter, a magnetic stir bar was put in the four-necked reactor, and a Dimroth condenser tube, a dropping funnel, a thermocouple and a nitrogen sealing balloon were attached thereto and the atmosphere of the four-neck reactor was replaced with nitrogen.

Pyridine (201 mL: 2,500 mmol) was fed and the mixture was, then, stirred with a magnetic stirrer (2,000 rpm) at 80° C. under heating until the ethylcellulose was dissolved.

After confirming that the solution became clear, 2-naphthoyl chloride (47.7 g: 250 mmol) dissolved in 100 mL of 1,4-dioxane was added dropwise. After the dropwise addition, the reaction solution was stirred for 8 hours and then added dropwise into 500 mL of methanol and stirred to prepare a homogeneous solution. The homogenous solution was added dropwise to 1 L of purified water and stirred to generate white precipitates, which were filtered, and the obtained precipitates were stirred in 1 L of purified water to wash.

Subsequently, a process including washing the white precipitates with 500 mL of methanol, followed by filtration was carried out twice. The white precipitates were then dried under vacuum using a vacuum oven at 60° C. for 5 hours to obtain a desired powdery cellulose derivative 9 (molar yield: 87%, yield: 12.87 g).

The cellulose derivative 9 was analyzed with 400 MHz-¹H-NMR manufactured by Bruker and was confirmed to be the target cellulose derivative and the degree of substitution was calculated. As a result, D₁=2.60 and D₂=0.40.

### (Cellulose Derivative 10: Provision of Cellulose Acetate Butyrate: D₁=2.70)

Cellulose acetate butyrate (CAB381-20) manufactured by Eastman Chemical Company was provided and used as cellulose derivative 10. As the value of D₂, that published by the manufacturer was adopted.

### <3. Formed Films>

In the following, methods for producing formed films using the above-described cellulose derivatives are described.

### (Formed Film Example 1) (Preparation of Film 1: D₃=0.17)

Cellulose derivative 1 was dissolved in methylene chloride super-hydride (manufactured by Wako Pure Chemical Industries, Ltd.) to prepare a 1 wt % diluted solution. Next, insoluble matter was filtered from the diluted solution by suction filtration using a hard filter paper No. 4 manufactured by Advantech Co., Ltd., and the diluted solution was concentrated using an evaporator to obtain a 10 wt % coating solution.

The coating solution was cast onto a biaxially stretched polyethylene terephthalate film (hereinafter referred to as a PET film) and thereafter, the coating solution was applied in a form of a uniform film using a bar coater so that a thickness after drying was about 50 to 60 μm.

The film was dried in a dry atmosphere at 80° C. for 5 minutes, in a dry atmosphere at 100° C. for 5 minutes, and in a dry atmosphere at 120° C. for 10 minutes to remove methylene chloride. After drying, the obtained film was peeled off from the PET film. The obtained film was fixed on an aluminum frame of 500 mm×300 mm and was dried in a dry atmosphere at 110° C. for 15 minutes to remove residual methylene chloride, and the film was referred to as film 1. The glass transition temperature of film 1 was measured and the result was 215° C.; the photoelastic coefficient was measured and the result was 12.0×10⁻¹² m²/N; the coefficient of linear thermal expansion was measured and the result was 65 ppm; and the water absorption rate was measured and the result was 0.29 wt %.

### (Formed Film Example 2) (Preparation of Film 2: D; =0.13)

A film was prepared using the same method as in Formed Film Example 1, except that cellulose derivative 2 was used, and the film was referred to as film 2. The glass transition temperature of film 2 was measured and the result was 218° C.; the photoelastic coefficient was measured and the result was 10.0×10⁻¹² m²/N; the coefficient of linear thermal expansion was measured and the result was 69 ppm; and the water absorption rate was measured and the result was 0.19 wt %.

### (Formed Film Example 3) (Preparation of Film 3: D₃=0.17)

A film was prepared using the same method as in Formed Film Example 1, except that cellulose derivative 3 was used, and the film was referred to as film 3. The glass transition temperature of film 3 was measured and the result was 213° C.; the photoelastic coefficient was measured and the result was 12.0×10⁻¹² m²/N; the coefficient of linear thermal expansion was measured and the result was 61 ppm; and the water absorption rate was measured and the result was 0.25 wt %.

### (Formed Film Example 4) (Preparation of Film 4: D₃=0.20)

A film was prepared using the same method as in Formed Film Example 1, except that cellulose derivative 4 was used, and the film was referred to as film 4. The glass transition temperature of film 4 was measured and the result was 218° C.; the photoelastic coefficient was measured and the result was 14.0×10⁻¹² m²/N; the coefficient of linear thermal expansion was measured and the result was 69 ppm; and the water absorption rate was measured and the result was 0.17 wt %.

### (Formed Film Example 5) (Preparation of Film 5: D₃=0.25)

A film was prepared using the same method as in Formed Film Example 1, except that cellulose derivative 5 was used, and the film was referred to as film 5. The glass transition temperature of film 5 was measured and the result was 204° C.; the photoelastic coefficient was measured and the result was 20.0×10⁻¹² m²/N; the coefficient of linear thermal expansion was measured and the result was 62 ppm; and the water absorption rate was measured and the result was 0.62 wt %.

### (Formed Film Example 6) (Preparation of Film 6: D₃=0.21)

A film was prepared using the same method as in Formed Film Example 1, except that cellulose derivative 6 was used, and the film was referred to as film 6. The glass transition temperature of film 6 was measured and the result was 205° C.; the photoelastic coefficient was measured and the result was 16.0×10⁻¹² m²/N; the coefficient of linear thermal expansion was measured and the result was 68 ppm; and the water absorption rate was measured and the result was 0.58 wt %.

### (Formed Film Example 7) (Preparation of Film 7: D₃=0.22)

A film was prepared using the same method as in Formed Film Example 1, except that cellulose derivative 7 was used, and the film was referred to as film 7. The glass transition temperature of film 7 was measured and the result was 205° C.; the photoelastic coefficient was measured and the result was 17.0×10⁻¹² m²/N; the coefficient of linear thermal expansion was measured and the result was 69 ppm; and the water absorption rate was measured and the result was 0.55 wt %.

### (Formed Film Example 8) (Preparation of Film 8: D₃=0.20)

A film was prepared using the same method as in Formed Film Example 1, except that cellulose derivative 8 was used, and the film was referred to as film 8. The glass transition temperature of film 8 was measured and the result was 219° C.; the photoelastic coefficient was measured and the result was 9.0×10⁻¹² m²/N; the coefficient of linear thermal expansion was measured and the result was 110 ppm; and the water absorption rate was measured and the result was 0.30 wt %.

### (Formed Film Example 9) (Preparation of Film 9: D₃=0.40)

A film was prepared using the same method as in Formed Film Example 1, except that cellulose derivative 9 was used, and the film was referred to as film 9. The glass transition temperature of film 9 was measured and the result was 145° C.; the photoelastic coefficient was measured and the result was 40.0×10⁻¹² m²/N; the coefficient of linear thermal expansion was measured and the result was 90 ppm; and the water absorption rate was measured and the result was 4.9 wt %.

### (Formed Film Example 10) (Preparation of Film 10: D₃=2.70)

A film was prepared using the same method as in Formed Film Example 1, except that cellulose derivative 10 (cellulose acetate butyrate: CAB381-20 manufactured by Eastman Chemical Company) was used, and the film was referred to as film 10. The glass transition temperature of film 10 was measured and the result was 141° C.; the photoelastic coefficient was measured and the result was 16.0×10⁻¹² m²/N; the coefficient of linear thermal expansion was measured and the result was 130 ppm; and the water absorption rate was measured and the result was 3.00 wt %.

### <4. Stretched Film>

In the following, methods for producing stretched films using the above-described formed films are described.

### Example 1

Film 1 was subjected to 70% free-end uniaxial stretching at 235° C. Pieces of film of 50 mm×40 mm were cut out from the center portion of the stretched film and were used for measurement of optical properties and durability tests. The results are shown in Table 1.

### Example 2

Film 2 was subjected to 50% free-end uniaxial stretching at 238° C. Pieces of film of 50 mm×40 mm were cut out from the center portion of the stretched film and were used for measurement of optical properties and durability tests. The results are shown in Table 1.

### Example 3

Film 3 was subjected to 60% free-end uniaxial stretching at 233° C. Pieces of film of 50 mm×40 mm were cut out from the center portion of the stretched film and were used for measurement of optical properties and durability tests. The results are shown in Table 1.

### Example 4

Film 4 was subjected to 30% free-end uniaxial stretching at 238° C. Pieces of film of 50 mm×40 mm were cut out from the center portion of the stretched film and were used for measurement of optical properties and durability tests. The results are shown in Table 1.

### Example 5

Film 5 was subjected to 50% free-end uniaxial stretching at 224° C. Pieces of film of 50 mm×40 mm were cut out from the center portion of the stretched film and were used for measurement of optical properties and durability tests. The results are shown in Table 1.

### Example 6

Film 6 was subjected to 100% free-end uniaxial stretching at 225° C. Pieces of film of 50 mm×40 mm were cut out from the center portion of the stretched film and were used for measurement of optical properties and durability tests. The results are shown in Table 1.

### Example 7

Film 7 was subjected to 100% free-end uniaxial stretching at 225° C. Pieces of film of 50 mm×40 mm were cut out from the center portion of the stretched film and were used for measurement of optical properties and durability tests. The results are shown in Table 1.

### Comparative Example 1

Film 8 was subjected to 50% free-end uniaxial stretching at 229° C. Pieces of film of 50 mm×40 mm were cut out from the center portion of the stretched film and were used for measurement of optical properties and durability tests. The results are shown in Table 1.

### Comparative Example 2

Film 9 was subjected to 50% free-end uniaxial stretching at 155° C. Pieces of film of 50 mm×40 mm were cut out from the center portion of the stretched film and were used for measurement of optical properties and durability tests. The results are shown in Table 1.

### Comparative Example 3

Film 10 was subjected to 50% free-end uniaxial stretching at 151° C. Pieces of film of 50 mm×40 mm were cut out from the center portion of the stretched film and were used for measurement of optical properties and durability tests. The results are shown in Table 1.

TABLE 1

| | | Example 1 | Example 2 | Example 3 | Example 4 | Example 5 |
|---|---|---|---|---|---|---|
| Component 1 | Cellulose derivative | Derivative 1 | Derivative 2 | Derivative 3 | Derivative 4 | Derivative 5 |
| | Silyl group 1 | TIPS | TIPS | TIPS | TIPS | TBDMS |
| | Silyl group 2 | TBDMS | TBDMS | TBDMS | TBDMS | — |
| | Alkyl group | — | — | — | — | — |
| | Acyl group 1 | 2-naphthoyl | 2-naphthoyl | 2-naphthoyl | 2-naphthoyl | 2-naphthoyl |
| | Acyl group 2 | — | — | — | — | — |
| | D1 *1) | 1.06 + 0.10 | 1.02 + 0.24 | 1.02 + 0.32 | 0.92 + 0.12 | 1.15 |
| | D2 | 0.17 | 0.13 | 0.17 | 0.20 | 0.25 |
| | D1 + D2 | 1.33 | 1.39 | 1.51 | 1.24 | 1.40 |
| Total degree of substitution by acyl group D₃ | | 0.17 | 0.13 | 0.17 | 0.20 | 0.25 |
| Formed film | | Film 1 | Film 2 | Film 3 | Film 4 | Film 5 |
| Photoelastic coefficient K (×10⁻¹² m²/N) | | 12.0 | 10.0 | 12.0 | 14.0 | 20.0 |
| Glass transition temperature (Tg) | | 215 | 218 | 213 | 218 | 204 |
| Water absorption rate (wt %) | | 0.29 | 0.19 | 0.25 | 0.17 | 0.62 |
| Coefficient of linear thermal expansion (ppm) | | 65 | 69 | 61 | 69 | 62 |
| Number average molecular weight (Mn) | | 71,000 | 69,000 | 72,000 | 68,000 | 72,000 |
| Weight average molecular weight (Mw) | | 153,000 | 165,000 | 151,000 | 149,000 | 155,000 |
| Stretching conditions | Ratio (%) | 70 | 50 | 60 | 30 | 50 |
| | Temperature (° C.) | 235 | 238 | 233 | 238 | 224 |
| Stretched film | Thickness (μm) | 50 | 45 | 42 | 43 | 41 |
| | Re(550) (nm) | 147 | 153 | 150 | 123 | 81 |
| | Re(450)/Re(550) | 0.82 | 0.92 | 0.84 | 0.84 | 0.63 |
| | Haze (%) | 1.33 | 0.79 | 1.59 | 0.59 | 0.75 |
| | Rate of change in in-plane Re after dry | −0.32% | −0.42% | −0.58% | −0.46% | −0.38% |
| | heat test (80° C. × 1000 hr) | | | | | |
| | Rate of change in in-plane Re after wet | −0.43% | −0.38% | −0.48% | −0.32% | −0.52% |
| | heat test (60° C./90% RH × 1000 hr) | | | | | |

| | | | Comparative | Comparative | Comparative |
|---|---|---|---|---|---|
| | Example 6 | Example 7 | Example 1 | Example 2 | Example 3 |
| Component 1 | Derivative 6 | Derivative 7 | Derivative 8 | Derivative 9 | Derivative 10 |
| | TBDMS | TBDMS | TBDMS | — | — |
| | — | — | — | — | — |
| | — | — | — | Ethyl | — |
| | 2-naphthoyl | 2-naphthoyl | 2-naphthoyl | 2-naphthoyl | n-butanoyl |
| | — | — | — | — | Acetyl |
| | 1.20 | 1.23 | 1.58 | 2.60 | — |
| | 0.21 | 0.22 | 0.20 | 0.40 | 2.70 *2) |
| | 1.41 | 1.45 | 1.78 | 3.00 | 2.70 |

| Total degree of substitution by acyl group D₃ | | 0.21 | 0.22 | 0.20 | 0.40 | 2.70 |
|---|---|---|---|---|---|---|
| Formed film | | Film 6 | Film 7 | Film 8 | Film 9 | Film 10 |
| Photoelastic coefficient K (×10⁻¹² m²/N) | | 16.0 | 17.0 | 9.0 | 40.0 | 16.0 |
| Glass transition temperature (Tg) | | 205 | 205 | 219 | 145 | 141 |
| Water absorption rate (wt %) | | 0.58 | 0.55 | 0.30 | 4.90 | 3.00 |
| Coefficient of linear thermal expansion (ppm) | | 68 | 69 | 110 | 90 | 130 |
| Number average molecular weight (Mn) | | 78,000 | 68,000 | 70,000 | 56,000 | 70,000 |
| Weight average molecular weight (Mw) | | 162,000 | 158,000 | 162,000 | 496,000 | 155,000 |
| Stretching conditions | Ratio (%) | 100 | 100 | 50 | 50 | 50 |
| | Temperature (° C.) | 225 | 225 | 229 | 155 | 151 |
| Stretched film | Thickness (μm) | 47 | 46 | 50 | 45 | 131 |
| | Re(550) (nm) | 130 | 116 | 134 | 160 | 138 |
| | Re(450)/Re(550) | 0.69 | 0.65 | 0.86 | 0.89 | 0.89 |
| | Haze (%) | 1.00 | 0.75 | 0.69 | 1.95 | 2.48 |
| | Rate of change in in-plane Re after | −0.41% | −0.37% | −0.30% | −6.30% | −4.60% |
| | dry heat test (80° C. × 1000 hr) | | | | | |
| | Rate of change in in-plane Re after | −0.55% | −0.58% | −0.80% | −6.40% | −2.50% |
| | wet heat test (60° C./90% | | | | | |
| | RH × 1000 hr) | | | | | |

In Table 1, TIPS and TBDMS refer to a triisopropylsilyl group and a tertiary butyldimethylsilyl group, respectively.
*1) In the case where the value of D1 is expressed as a sum, the former and the latter refer to a degree of substitution by a TIPS group and a degree of substitution by a TBDMS group, respectively.
*2) Degree of substitution by a n-butanoyl group is 1.70 and that by an acetyl group is 1.0.

From Table 1, the formed films of Examples 1, 2, 3, 6 and 7 satisfy all of the preferred coefficient of linear thermal expansion (100 ppm/° C. or less), the preferred heat resistance (glass transition temperature Tg>180° C.), the preferred photoelastic coefficient (5×10⁻¹² m²/N to 30×10⁻¹² m²/N) and the preferred water absorption rate (2.0% or less). Further, the stretched film thereof satisfy all of the optical properties and the mechanical properties, including the preferred in-plane retardation (130 nm to 160 nm), the preferred reverse wavelength dispersion (Re(450)/Re(550)=0.50 to 0.99), the preferred dry heat durability (amount of change in the in-plane retardation Re after dry heat durability test (80° C.×1,000 hrs) being within 2.0% of the initial value) and the preferred wet thermal durability (amount of change in the in-plane retardation Re being within 4.0% of the initial value). Additionally, since the preferred haze (2.00% or less) is also satisfied, it is also possible to evaluate transparency as high. Moreover, the film thickness, 50 μm or less, is sufficiently low.

For the stretched films of Examples 4 and 5, the in-plane retardation was outside the above-described range, but other properties were within the preferred ranges. Therefore, the stretched films of Examples 4 and 5 can be said to have favorable properties which are equivalent to those of the stretched films of Examples 1, 2, 3, 6 and 7.

In contrast, for the formed films and the stretched films of Comparative Examples 1 to 3, various physical properties remained in a trade-off relationship.

The present invention is not limited to the above-described embodiments and various modifications are possible within the scope of claims. Embodiments obtained by appropriately combining technical means respectively disclosed in different embodiments and different Examples are also included in the technical scope of the present invention. Further, by combining technical means that are respectively disclosed in the embodiments and the Examples, new technical features can be formed.

### INDUSTRIAL APPLICABILITY

The present invention can be applied to a polymer material for a transparent film applicable as a component of various electronic devices and to an image display apparatus such as liquid crystal display apparatus or an organic EL using the transparent film as a structural element.

1: A phase difference film having a coefficient of linear thermal expansion of 100 ppm/° C. or less in absolute value, a glass transition temperature of 180° C. or more, a photoelastic coefficient of 5×10⁻¹² m²/N to 30×10⁻¹² m²/N and a water absorption rate of 2.0 wt % or less.

2: A phase difference film having a coefficient of linear thermal expansion of 100 ppm/° C. or less in absolute value, a photoelastic coefficient of 5×10⁻¹² m²/N to 30×10⁻¹² m²/N and a water absorption rate of 2.0 wt % or less.

3: The phase difference film according to claim 1,
wherein the phase difference film has an initial value of in-plane retardation Re(550) of 130 nm to 160 nm,
when the phase difference film is subjected to a dry heat durability test (80° C.×1,000 hrs), an amount of change in the in-plane retardation Re is within 2.0% of the initial value, and
when the phase difference film is subjected to a wet heat durability test (60° C./90% RH×1,000 hrs), an amount of change in the in-plane retardation Re is within 4.0% of the initial value.

4: The phase difference film according to claim 1, wherein the phase difference film has a thickness of 50 μm or less and reverse wavelength dispersion Re(450)/Re(550) of 0.50 to 0.99.

5: The phase difference film according to claim 1, wherein the phase difference film comprises a polymer material containing at least one cellulose derivative represented by the formula (1) 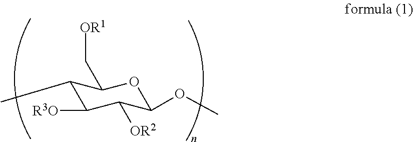
wherein, in the formula (1):
R¹, R² and R³ are each independently selected from the group consisting of a hydrogen atom, an organosilyl group, an acyl group and a second aliphatic group, where the organosilyl group has a first aliphatic group, an unsaturated aliphatic group or an aromatic group;
R¹, R² and R³ are selected such that the cellulose derivative comprises (a) the organosilyl group and (b) the acyl group or the second aliphatic group; and
n is a positive integer,
wherein a degree of substitution (D₁) by the organosilyl group or the second aliphatic group in the cellulose derivative is 0.80 to 1.55,
a degree of substitution (D₂) by the acyl group in the cellulose derivative is 0.10 to 2.00,
a degree of substitution (D₃) by the acyl group in the polymer material is 0.10 to 2.00, and
the degree of substitution (D₁) and the degree of substitution (D₂) satisfy D₁+D₂≤3.0.

6: The phase difference film according to claim 5, wherein the cellulose derivative comprises (a) the organosilyl group and (b) the acyl group.

7: The phase difference film according to claim 5, wherein the organosilyl group is a trisubstituted organosilyl group.

8: The phase difference film according to claim 5, wherein the organosilyl group has at least one selected from the group consisting of a tertiary butyl group, a tertiary hexyl group and an isopropyl group.

9: The phase difference film according to claim 5, wherein the acyl group is a 1-naphthoyl group or a 2-naphthoyl group.

10: The phase difference film according to claim 1, wherein the phase difference film has a water absorption rate of 0.1 wt % or more and 2.0 wt % or less.

11: A circular polarizing plate, comprising the phase difference film according to claim 1.

12: An image display device comprising the circular polarizing plate according to claim 11.

13: The phase difference film according to claim 8, wherein the organosilyl group is selected from the group consisting of a tertiary butyldimethylsilyl (TBDMS) group, a tertiary butyldiphenylsilyl (TBDPS) group, a tertiary hexyldimethylsilyl (THDMS) group and a triisopropylsilyl (TIPS) group.

14: The phase difference film according to claim 5, wherein the cellulose derivative comprises (a) the organosilyl group and (b) the second aliphatic group.

15: The phase difference film according to claim 5, wherein the polymer material contains one cellulose derivative represented by the formula (1).

16: The phase difference film according to claim 5, wherein the polymer material contains at least two cellulose derivatives each represented by the formula (1).

17: The phase difference film according to claim 5, wherein the cellulose derivative has a number average molecular weight of 10,000 to 400,000.

18: The phase difference film according to claim 5, wherein the phase difference film further comprises at least one additive selected from the group consisting of a plasticizer, a heat stabilizer, an ultraviolet stabilizer, an in-plane retardation increasing agent and a filler.
